(19) United States
(12) Patent Application Publication
(10) Pub. No.: US 2016/0283979 A1
(43) Pub. Date: Sep. 29, 2016

(54) CONTEXTUALLY AWARE BILLBOARD DISPLAY DEVICES USING WIRELESS BEACON DEVICE COMMUNICATIONS

(71) Applicant: PAYPAL, INC., San Jose, CA (US)

(72) Inventors: Geoffrey W. Chatterton, Santa Clara, CA (US); Kamal Zamer, Austin, TX (US)

(21) Appl. No.: 14/667,115

(22) Filed: Mar. 24, 2015

(51) Int. Cl. G06Q 30/02; H04W 4/02; H04W 40/24; G06Q 10/00

(52) U.S. Cl. CPC G06Q 30/0261; G06Q 10/20; H04W 4/021; H04W 40/244

(57) ABSTRACT

There are provided systems and methods for contextually aware billboard display devices using wireless beacon device communications. A service provider may utilize one or more wireless notifications at or nearby a location to connect with a communication device of a user as the user moves into proximity of the wireless beacon's short range wireless communications at or nearby the location. Once connected, the wireless beacon may provide an identifier for the user to the service provider. The service provider may utilize context information for the location to determine needs or interests of the user and/or a vehicle for the user. The service provider may generate a notification, such as an advertisement, that may be communicated to the user through billboards that the user may pass. The notifications may be for car maintenance conditions or vehicle user requirements. The notifications may also be for nearby merchants and available items.

### TECHNICAL FIELD

The present application generally relates to wireless beacons and more specifically to contextually aware billboard display devices using wireless beacon device communications.

### BACKGROUND

A user may operate a vehicle while traveling between two or more points. Along the route, the user may view billboards, caution light displays, and other notices, which may include advertisements for local merchants and items as well as advisory warnings to the user. However, such information is generic to all users travelling the route, and is not particular to a certain user. Thus, many users may be uninterested by certain signage, while other users may choose to ignore any notices presented to the user. Thus, advertisements and warnings may not be most efficiently conveyed to users, while warnings may go unnoticed.

Further, users may be unaware of certain location based context information and/or vehicle information that may be pertinent to the user. For example, a user travelling through a desert or through an especially cold area may be unaware that certain radiator and/or interior heating/cooling requirements of a vehicle should be met. Other travel conditions may relate to tire pressure, oil requirements, and fuel requirements (e.g., in the case of an exceedingly long distance between gas stations). Moreover, vehicle requirements may also be specific to the particular vehicle the user is driving, such as low tire pressure of the vehicle or other maintenance issues. However, without being apprised of the vehicle's condition and/or the conditions and requirements for vehicle usage in and around a location, users may place themselves in danger of vehicle malfunction.

### BRIEF DESCRIPTION OF THE DRAWINGS

FIG. 1 is a block diagram of a networked system suitable for implementing the processes described herein, according to an embodiment;

FIG. 2 is an exemplary environment having a travel route where users are provided contextually relevant notifications on billboard display devices and other communication devices, according to an embodiment;

FIG. 3 is an exemplary system environment having a user's communication device and a billboard display device receiving contextually relevant notifications based on location context information, vehicle information, and user information, according to an embodiment;

FIG. 4 is a flowchart of an exemplary process for contextually aware billboard display devices using wireless beacon device communications, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that provide contextually aware billboard display devices using wireless beacon device communications. Systems suitable for practicing methods of the present disclosure are also provided.

A service provider may provide short range wireless communications with a device for a user at a location, such as through wireless beacons having a transceiver using one or more of Bluetooth Low Energy (BLE) communication protocol, LTE Direct communication protocol, WiFi communication protocol, etc. These beacons may be set up at a location and communicate with devices to alert users of check-in services through their device and/or connect with the device to receive an identifier associated with the user (e.g., for the user and/or the user's device). The beacons may establish a connection with a server for the service provider to communicate information to effectuate a check-in/connection at the location for the user and communicate the identifier to the server. The beacons may provide additional functionality, such as communicating information back to the user's device and/or other nearby devices in communication with the wireless beacon. The beacons may communicate with the devices directly, including information stored in the beacons. The beacons may also allow the user's device to communicate with a device or server attached to, or in communication with, the beacon, such as a device nearby the beacons or server of the service provider.

For example, the short range wireless beacons may be established at or nearby a location, such as along and throughout a travel route, before or nearby a billboard having an electronic display device, before or nearby an event or accident on the travel route, and/or before, at, or nearby a merchant on the travel route. The beacons may employ BLE, LTE Direct, WiFi, or other communications that emit a signal receivable by the user's device. The communication may include an identifier for the beacon, the user, the merchant, and/or the payment provider. A user may set up their communication device to passively monitor for BLE, LTE Direct, WiFi, or other communication signals from the beacon. When the communication device detects the signal and verifies the one or more identifiers, both the communication device and the beacon may ramp up in power and establish a connection, where the connection may further enable the communication device to communicate with the service provider (e.g., communicate an identifier to the service provider received from the communication device). The connection may be completed automatically when the communication device is in range of the beacon, or may be completed after prompting the user to check-in when the communication device is in range of the beacon. The connection established with the beacon may generate connection information identifying that the user has checked-in to the location through the wireless beacon. The beacon may provide the connection information (e.g., an identifier for the user and/or communication device) to the service provider server to identify the user as located at or nearby the location for the wireless beacon.

The user may be travelling in a vehicle when the user's communication device connects to the wireless beacon. The communication device may correspond to a mobile smart phone of a user or may correspond to a device within or associated with the vehicle (e.g., a computing device of the vehicle, a console device of the vehicle, and/or heads up display device of the vehicle). Thus, once the user is identified with the location based on the connection to the beacon (e.g., when the service provider receives the identifier for the user/communication device from the beacon), the service provider may identify location context information for the location. Location context information may correspond to contextual information about the location, such as occurrences at or nearby the location, available merchants at or nearby the location (including those along a travel route of the user) offering goods and services (referred to herein as an “item” or “items”), and/or vehicle use requirements, guidance, and suggestions for operation of a vehicle at or nearby the location. For example, location context information may include weather, traffic, and/or accidents at the location or along a travel route throughout and nearby the location. Such information may affect a drive through the location in a vehicle by the user. Location context information may also include merchants available that offer items for sale, which may include both personal items (e.g., food, drink, or other shopping interests) and vehicle use and maintenance items (e.g., gas, oil, tires, radiator fluid, lights, air conditioner and heater repair or maintenance, etc.).

Where the location context information corresponds to vehicle use requirements, guidance, and suggestions for operation of a vehicle at or nearby the location, the location context information may include information about a type of vehicle for use or nearby the location, a type of tire required at or nearby the location, a type of vehicle drivetrain required at or nearby the location, a type of safety belt or harness required at or nearby the location, required safety lighting at or nearby the location, necessary oil requirements at or nearby the location, necessary radiator fluid requirements at or nearby the location, required tire pressure at or nearby the location, necessary interior cooling or heating at or nearby the location, necessary gas levels (or other fuel or power levels, including battery power, natural gas, propane, or other type of fuel/power) at or nearby the location, and necessary electrical requirements at or nearby the location. Such information may be tied to vehicle requirements at or nearby the location and may be mandatory (e.g., the vehicle may not proceed without meeting the requirements) or suggested (e.g., the vehicle may proceed but may have difficulties or encounter issues, such as impassable terrain, breakdown, etc.). The information may also be guidance or suggestions for the area, such as a suggested fuel amount based on a distance to a next refueling station, suggested heating/cooling for an interior of the vehicle to be comfortable, an amount of oil or radiator fluid to prevent damage to an engine, or other guideline for care and maintenance of the user's vehicle. In such embodiments, the vehicle requirements, suggestions, and/or guidance may be set by an administrator for the location, including governmental entities, or may be set from crowd sourced information based on vehicle information that has travelled through the location and/or travel route through and nearby the location.

Using the identifier, the service provider may further determine vehicle information. The vehicle information may include vehicle make, model, year, drivetrain, transmission, and other general information, as well as information specific to the vehicle, such as mileage, condition, oil level and condition, previous maintenance and accident history, and other condition and maintenance parameters. The vehicle information may be pulled from the communication device of the user/vehicle, or may be accessed from a database and/or retrieved from a maintenance provider entity for the user/vehicle (including rental car entities). The vehicle information may further include information about passengers, the driver, cargo, and/or other information about users and items in the vehicle. In other embodiments, the service provider may further access the user information, such as from a database or through pulling the information from the communication device of the user/vehicle. Using the location context information and the vehicle information, the service provider may determine a notification for the user. The notification may be communicated to a billboard display device that the user may pass as the user is operating the vehicle at or nearby the location (e.g., along the travel route), which may display the notification to the user. The notification may be communicated to the billboard display device over a network connection or may be communicated to one or more wireless beacons, which may utilize short range wireless communications to transmit the notification to the billboard display device.

The notification may include an advertisement for a merchant offering one or more items that may be of interest to the user. For example, if the location context information requires a certain type of tire (e.g., snow tires or chains), then a local merchant to the location that provides snow tires and/or chain installation may be provided in the notification. The notification may also be for other items of particular interest to the user based on the condition of the vehicle and/or the specific location. In such an embodiment, the notification may alert the user that tire pressure of their vehicle is low and maintenance is available nearby. The notification may be generated in specific instances where maintenance is of higher priority, such as filling radiator fluid or fixing an air conditioner that may malfunction where the user is traveling through a desert location. Thus, the notification may be based both on the requirements, guidelines, and suggestions for vehicle usage in and around the location, as well as the vehicle information.

In further embodiments, the notification may be generated based on user information about the users in the vehicle, for example, by offering rest stops and restaurants to families travelling through a location or a coffee stop to a businessman travelling by a location. Thus, the notification may include information about merchants selling items of particular interest to the user as well as for the vehicle. The notification may also include an alert of traffic and weather conditions at or nearby the location. In such embodiments, the notification may be generated to alert users of upcoming traffic, but may also alert specific users to upcoming traffic or weather to provide the users with adequate prior warning to stop the vehicle or make adjustments. The notification alerting the user of traffic and/or weather conditions may also be communicated to the user through a mobile smart phone, or a vehicle's computing device. The amount of time the notification is displayed for may vary depending on user and other factors, including rate of travel of the user, size of the display, lighting on the display, time of day, and weather conditions. In particular, the notification may be displayed only during the time the user may actually see or determine content of the display. Once the user has passed the display (e.g., user vehicle/device being detected as passing the display), the notification may be changed, such as for another user.

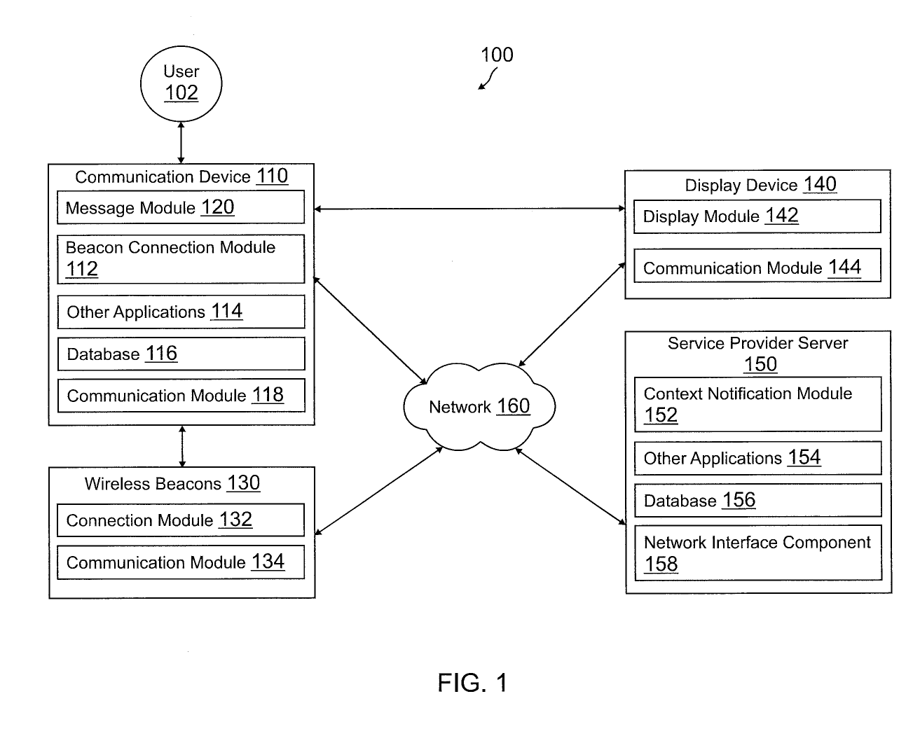

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a communication device 110, wireless beacons 130, a display device 140 and a service provider server 150 in communication directly using short range wireless communications and/or over a network 160. User 102, may operate a vehicle while in possession of communication device 110 at or nearby a location where one or more of wireless beacons 130 are established. Communication device 110 may pair with the one or more of wireless beacons 130 to provide an identifier for user 102/communication device 110 to the one or more of wireless beacons 130 using short range wireless communications so as to associate user 102 with the one or more of wireless beacons 130 (e.g., in proximity to the one or more of wireless beacons 130). The identifier may be communicated by the one or more of wireless beacons 130 to service provider server 150, which may determine location context information associated with the location for the one or more of wireless beacons 130 and access vehicle and/or user information for the vehicle and/or user 102, respectively. Service provider server 150 may then determine a notification, which may be communicated to display device 140 for display to user 102 as user 102 approaches display device 140. A best time to display the notification may be determines to that display of the notification to the user is maximized (e.g., based on a distance, speed, and/or visual condition for user 102). The notification may further be communicated back to communication device 110 for display to user 102.

Communication device 110, wireless beacons 130, display device 140, and service provider server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Communication device 110 may be implemented using any appropriate hardware and software configured for wired and/or wireless communication with wireless beacons 130, display device 140, and/or service provider server 150. For example, in one embodiment, communication device 110 may be implemented as a personal computer (PC), a smart phone, laptop/tablet computer, wristwatch with appropriate computer hardware resources, eyeglasses with appropriate computer hardware (e.g. GOOGLE GLASS ®), other type of wearable computing device, and/or other types of computing devices capable of transmitting and/or receiving data, such as an IPAD® from APPLE®. In various embodiments, communication device 110 may also correspond to a vehicle computing device, such as a console computing device and/or heads up display device. However, communication device 110 may also correspond to a mobile smart phone, or other device in possession of user 102 while travelling in a vehicle, where the vehicle may include a vehicle computing device. In such embodiments, communication device 110 may further connect to the vehicle computing device, such as through a wired connection and/or short range wireless communications. Although a communication device is shown, the communication device may be managed or controlled by any suitable processing device. Although only one communication device is shown, a plurality of communication devices may function similarly.

Communication device 110 of FIG. 1 contains a message module 120, beacon connection module 112, other applications 114, a database 116, and a communication module 118. Message module 120, beacon connection module 112, and other applications 114 may correspond to executable processes, procedures, and/or applications with associated hardware. In other embodiments, communication device 110 may include additional or different software as required.

Message module 120 may correspond to one or more processes to execute modules and associated specialized hardware of communication device 110 to receive one or more notifications or messages from service provider server 150 and/or another device or server (e.g., wireless beacons 130 and devices of other users/vehicles in communication with wireless beacons 130 and/or communication device 110) and output the messages to user 102, such as through audio output, visual output, and/or audiovisual output. In this regard, message module 120 may correspond to specialized hardware and/or software utilized to provide a convenient interface to communication notifications and messages to user 102 using an output module of communication device 110. Message module 120 may receive a notification or message from communication module 118 communicated by wireless beacons 130, service provider server 150 over network 160, and/or a device of another user/vehicle through short range wireless communications. The notification/message may include an advertisement for display to user 102, such as an advertisement for a merchant and/or available item determined by service provider server 150, as explained herein. In such embodiments, the notification/message may include targeted advertisement, which may enable the item/merchant of interest to user 102 as well as information allowing user 102 to visit the merchant and/or purchase the item to be displayed. The notification may be interactive, allowing for contact of the merchant, lookup of a merchant address, and/or preordering of the item with the merchant For example, message module 120 may be implemented as a user interface where user 102 may view the information and then make selections from the notification, including purchase/reservation of an item or place, map directions to a merchant location, and/or phone/text call to the merchant, which may be handled by message module 120 and/or other applications 114 of communication device 110.

Where the advertisement is based on needs of a vehicle that user 102 is travelling in (e.g., a requirement for snow tires/chains, required fuel stops, oil change, etc.), the advertisement may further alert user 102 of the condition and/or maintenance parameter of the vehicle at issue, as well as the potential danger of violation of the vehicle requirement, guideline, or suggestion, including legal fines and charges, potential vehicle malfunction and/or breakdown, or other issues. Thus, the notification may include information giving rise to the notification. Message module 120 may be in connection with a vehicle device or may correspond to the vehicle device (e.g., communication device 110 is a console computing device of the vehicle), so that message module 120 may verify the status, condition, and/or maintenance parameter of the vehicle and/or issue one or more safety precautions of the vehicle. Message module 120 may further provide feedback to service provider server 150 and/or another entity, for example, on acceptance of the advertisement and servicing of the vehicle and/or on a misrepresented or incorrect vehicle maintenance parameter/condition.

The notification/message may also correspond to an alert or warning of upcoming traffic or weather, or impending weather and or conditions at and nearby a location, as discussed herein. In such embodiments, message module 120 may display the notification/message with information causing generation of the notification/message. Message module 120 may allow user 102 to view (e.g., on a map) the cause for the alert, as well as traffic conditions surrounding the cause for the alert, through an interface of message module 120 and/or other applications 114. Message module 120 may receive such notifications from wireless beacons 130 as a vehicle that user 102 is travelling in passes within a proximity of the upcoming traffic/weather alert (e.g., where one or more of wireless beacons 130 is established at a mile marking before the traffic/weather condition, as explained herein). Message module 120 may also receive notifications from nearby communication and/or vehicle devices using short range wireless communications, for example, one of near field communication, radio communication, infrared communication, Bluetooth communication, Bluetooth Low Energy (BLE) communication, LTE Direct communication, and WiFi communication.

Beacon connection module 112 may correspond to one or more processes to execute modules and associated devices of communication device 110 to establish a connection with one or more of wireless beacons 130 established at or nearby a location for example, along a travel route (e.g., street, highway, or other route traversable by a vehicle). In this regard, beacon connection module 112 may correspond to specialized hardware and/or software utilized to connect to one or more of wireless beacons 130 in order to receive short range wireless communications from wireless beacons 130 at the location and transmit information to wireless beacons 130, including check-in information for a check-in process with display device 140 (e.g., an identifier for user 102/communication device 110). Wireless beacons 130 may be located within, nearby, or associated with the location, for example, a location along a travel route, including mile markers, sights, exits, or located approaching or on the border and within a larger location, such as a city, county, national park, or other location. Beacon connection module 112 may communicate with one or more of wireless beacons 130 to generate connection information for user 102, which identifies user 102 as in proximity to the one or more of wireless beacons 130 using an identifier for user 102 and/or communication device 110. The connection information may identify user 102 as located at or nearby the location (e.g., at a location on a travel route, approaching or within a town/city/park, etc.). The connection information may include an identifier for user 102 and/or communication device 110, which may be communicated to service provider server 150 by wireless beacons 130, as discussed herein.

Beacon connection module 112 may execute in the background of an operating system of communication device 110 and be configured to establish connections, using communication module 118 of communication device 110, with one or more of wireless beacons 130. The connection may be established with or without user input from user 102. For example, wireless beacons 130 may broadcast a token, such as a universally unique identifier (UUID), for reception by beacon connection module 112, as will be explained in more detail herein. Beacon connection module 112 may utilize communication module 118 of communication device 110 to receive the token. If beacon connection module 112 acknowledges the UUID as identifying wireless beacons 130, display device 140, and/or service provider server 150 (e.g., if beacon connection module 112 determines the UUID corresponds to a request to complete a check-in), beacon connection module 112 may transmit an identifier corresponding to user 102 and/or communication device 110 back to the one or more of wireless beacons 130 transmitting the first identifier. Beacon connection module 112 may utilize communication module 118 of communication device 110 to communicate with one or more of wireless beacons 130 (e.g., over near field communication, Bluetooth, Bluetooth Low Energy, radio, infrared, LTE Direct, or other connection). The identifier from communication device 110 may include, be transmitted with, concatenated with, or otherwise bundled with the identifier received from the one or more of wireless beacons 130 transmitting the first identifier.

In other embodiments, different information may be transmitted to wireless beacons 130, such as a name or other personal information for user 102, as well as user information and/or vehicle information. Thus, the information transmitted to wireless beacons 130 does not need to be utilized to process and/or complete a check-in with display device 140 in all embodiments. In other embodiments, wireless beacons 130 may pull user and/or vehicle information from communication device 110 and/or a mobile smart phone or vehicle device associated with user 102/the vehicle user 102 is travelling in, as explained herein, or may be determined from one or more other available devices, servers, and/or databases accessible by service provider server 150. Once a connection is established with beacon connection module 112, one or more of wireless beacons 130 may communicate information to communicate device 110, such a notification and/or message, which may be displayed to user 102 through message module 120.

In various embodiments, one or more features of message module 120 and/or beacon connection module 112 may be incorporated in the same application so as to provide their respective features in one application.

Communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 160, or other types of applications. Other applications 114 may also include email, texting, voice and IM applications that allow a user to send and receive emails, calls, texts, and other notifications through a network. In various embodiments, other applications 114 may include financial applications, such as banking, online payments, money transfer, or other applications associated with payment provider server 170. Other applications 114 may include browser, social networking, and/or mapping applications, which may also be used in conjunction with beacon connection module 112 and/or message module 120. For example, one or more of the applications offered by other applications 114 may be utilized to provide payment for advertisements presented through message module 120, map to merchant locations, traffic/weather conditions, or other areas of interest from notifications presented through message module 120, or provide other functionality. Other applications 114 may contain software programs, executable by a processor, including a graphical user interface (GUI) configured to provide an interface to the user.

Communication device 110 may further include database 116 which may include, for example, identifiers such as operating system registry entries, cookies associated with message module 120, beacon connection module 112, and/or other applications 114, identifiers associated with hardware of communication device 110, or other appropriate identifiers, such as identifiers used for payment/user/device authentication or identification. Identifiers in database 116 may be used by a payment/service provider to associate communication device 110 with a particular account maintained by the payment/service provider. Database 116 may include communication device tokens and/or encryption keys, including an encryption key of wireless beacons 130, and/or service provider server 150. Database 116 may include received information, including notifications and notification attachments, including mapping, purchase, and other information.

Communication device 110 includes at least one communication module 118 adapted to communicate with wireless beacons 130 and/or service provider server 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with wireless beacons 130 using short range communications, such as Bluetooth Low Energy, LTE Direct, radio frequency, infrared, Bluetooth, and near field communications.

Wireless beacons 130 may be maintained, for example, by a merchant for display device 140, service provider server 150, and/or an administrator for a location where one or more of wireless beacons 130 are established. Wireless beacons 130 may be implemented using any appropriate hardware and software configured for wireless communication with communication device 110, display device 140, and/or service provider server 150. For example, in one embodiment, wireless beacons 130 may be implemented as a dongle device including a hardware processor and a communication module, for example, connected to device at the location of the merchant. Wireless beacons 130 may also be implemented as a device incorporated within a personal computer (PC), a smart phone, laptop/tablet computer, and/or other types of computing devices capable of transmitting and/or receiving data. Wireless beacons 130 may also act as a stand-alone device including a processor, communication module, and/or network interface component configured to communicate with communication device 110, display device 140, and/or service provider server 150. In various embodiments, wireless beacons 130 may be configured to establish connections and communication information with one or more other devices, including mobile smart phones and vehicle computing devices (e.g., a console computing device and/or heads up display device), where such devices do not include communication device 110. Although wireless beacons 130 are described as a plurality of wireless beacons set up at, within, nearby, and/or otherwise associated with a location (e.g., along a travel route where display device 140 is viewable along the travel route), in various embodiments, wireless beacons 130 may correspond to a single wireless beacon established at or otherwise associated with the location.

Wireless beacons 130 may be located at a physical location corresponding to display device 140 (e.g., prior to display device 140 along a travel route) and/or another location of interest (e.g., prior to a merchant location, accident or weather condition, etc.). Wireless beacons 130 of FIG. 1 contains processes, procedures, and/or applications executable by a hardware processor, for example, a software program, configured to interact with communication device 110, display device 140, and/or service provider server 150. Thus, regardless of the implementation of wireless beacons 130, as discussed above, each of wireless beacons 130 utilize a connection module 132 and a communication module 134. In other embodiments, wireless beacons 130 may include additional or different software and devices as required.

Connection module 132 may correspond to an application for transmitting requests to establish a connection between a device (e.g., communication device 110) and one of wireless beacons 130. The requests may be unique to each of wireless beacons 130 and form a connection with only the matching one of wireless beacons 130. Thus, wireless beacons 130 may utilize short range wireless communications (e.g., BLE, LTE Direct, WiFi, etc.) of wireless beacons 130 to transmit the requests to establish a connection, including an identifier such as a Universally Unique Identifier (UUID). If communication device 110 receives a request to establish the connection with wireless beacons 130 and responds with an identifier for user 102/communication device 110 (potentially including the UUID and other information necessary to effectuate a check-in for user 102), wireless beacons 130 to ramp up in power and create a connection between communication device 110 and one of wireless beacons 130.

Each of wireless beacons 130 may uniquely transmit the request to establish the connection with wireless beacons 130 as a short range wireless communication (e.g. a BLE protocol communication) including a “wake up” process and/or a token for the one of wireless beacons 130 transmitting the request. In other embodiments, the request and/or connection may utilize near field communication, radio communication, infrared communication, or Bluetooth communication. Additionally, although wireless beacons 130 may utilize BLE protocol communications to effectuate an “always on” type service where the UUID and “wake up” process are transmitted continuously, other communication protocols used to provide an “always on” service may include QUALCOMM® LTE Direct or similar device-to-device communication technology. BLE and LTE Direct may both be utilized to provide discovery of nearby devices to wireless beacons 130 (e.g., communication device 110) and establishment of a connection for data transfers.

Communication device 110 may only pick up the request based on the signal range and/or physical context for one of wireless beacons 130 transmitting the request within the location. For example, one of wireless beacons 130 established at or nearby a location and may be limited in range only to connect to communication device 110 if communication device 110 is located at, within, nearby, or otherwise associated with location (e.g., travelling by or through the location along a travel route). Once connected, connection information may be generated that may include an identifier for user 102/communication device 110. After connection module 132 receives an identifier from communication device 110, connection module 132 may communicate the connection information with the identifier to service provider server 150 for determination of one or more notifications for user 102. Additionally, connection module 132 may cause wireless beacons 130 to keep a communication channel open between communication device 110 and/or service provider server 150 for passing additional information, such as user information for user 102 and/or vehicle information for a vehicle that user 102 is utilizing. Connection module 132 may further pull information from communication device 110 and/or another device associated with user 102 and/or the vehicle, such as the aforementioned user and/or vehicle information.

In a similar manner as described above, connection module 132 may form connections with one or more other devices, such as display device 140. However, in other embodiments, connection module 132 may instead receive and communication information with one or more other devices using connection module 132 without establishing a connection by transmitting and receiving communications (e.g., data) using short range wireless communications. For example, connection module 132 may communicate a notification to display device 140 for display to user 102 as user 102 passes by display device 140 using short range wireless communications, where display device 140 is configured to receive and process the communications, as discussed herein. In other embodiments, connection module 132 may further communicate a notification to communication device 110 and/or another device (e.g., a mobile smart phone or vehicle device) when the device is in proximity to connection module 132 through the short range wireless communications. In such embodiments, connection module 132 may broadcast the information without establishing a prior connection to one or more of wireless beacons 130 by communication device 110, display device 140, and/or the other device, for example, where one or more of wireless beacons 130 received or determines that the device is within a proximity to the one or more of wireless beacons 130 and will receive the communications.

In various embodiments, wireless beacons 130 includes at least one communication module 134 adapted to communicate with communication device 110, display device 140, and/or service provider server 150. Communication module 134 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 134 may communicate with communication device 110 and/or display device 140 using short range communications, such as radio frequency, infrared, Bluetooth, and near field communications.

Display device 140 may be implemented using any appropriate hardware and software configured for wired and/or wireless communication with wireless beacons 130 and/or service provider server 150. For example, display device 140 may be implemented as a billboard display device or other type of visual display device configured to display one or more notifications. In this regard, display device 140 may include an output module having an audio, visual, and/or audiovisual output device that may present a notification received by display device 140. Display device 140 may include various types of output devices, including individual lights, LED displays, LCD displays, Plasma displays, CRT or other type of two-dimensional and three-dimensional display devices (including mechanical and/or segmented light display devices) Although only one display device is shown, a plurality of display devices may function similarly.

Display device 140 of FIG. 1 contains a display module 142 and a communication module 144. Display module 142 may correspond to one or more specialized output devices (e.g., a display screen and interface, a speaker or other audio output, etc.) and corresponding processes, procedures, and/or applications executable by a hardware processor of display device 140, for presentation of a notification to user 102. In this regard, display device 140 is viewable by user 102, for example, as user 102 passes display device 140 while travelling in a vehicle at or nearby a location corresponding to one or more of wireless beacons 130. In other embodiments, display device 140 may include additional or different hardware and software as required.

Display module 142 may correspond to one or more devices and processes to execute modules and associated display devices of display device 140 to receive and/or access a received notification from service provider server 150 through one or more of wireless beacons 130 and/or over network 160 and display the notification to user 102 when display device 140 is visible to user 102. In this regard, display module 142 may correspond to specialized hardware and/or software utilized by display device 140 that may first receive a notification and/or access a received notification. As discussed herein, the notification may correspond to an advertisement, alert, notice, combination of the aforementioned information elements, or other displayable information that may correspond to a location at or nearby display device 140 and location context information for such a location. Once the notification is determined by service provider server 150, the notification may be communicated to display device 140 using wireless beacons 130 (e.g., through short range wireless communications between one or more of wireless beacons 130 and display device 140) or over a network connection between display device 140 and service provider server 150. Once received, display module 142 may display the notification or store the notification to a memory (e.g., a database stored to a non-transitory memory) of display device 140 for later display.

The notification may be for immediate display by display module 142. In such embodiments, once received, display module 142 may display the notification, which may be viewable by user 102 to inform user 102 of the notification and the information included within the notification. Display module 142 may utilize an output display device, which may convey the notification to user 102. For example, display module 142 may utilize a billboard display device, which may output the notification. In other embodiments, the notification may be for later display to user 102. Service provider server 150 may determine a best time to have display device 140 display the notification to user 102, for example, using a speed of travel by user 102 at or nearby a location for which service provider server 150 has determined user 102 is passing through or nearby, a user location for user 102 at or nearby the location (e.g., determined based on the beacon of wireless beacons 130 connected to communication device 110 and/or through location based information, such as GPS coordinates), and/or a device location of display device 140 at or nearby the location. Service provider server 150 may communicate the notification to display device 140 utilizing the best time (with, for example, data transmission delay in communication of a signal to display device 140 through wireless beacons 130 or over network 160) or may communicate the notification for later display at this best time. In the latter embodiments, display module 142 may later access the notification and display the notification at the best time so that user 102 is more likely to view the notification and/or the notification will be displayed when user 102 is in sight of display device 140.

Display device 140 includes at least one communication module 144 adapted to communicate with communication device 110, wireless beacons 130, and/or service provider server 150. In various embodiments, communication module 144 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 144 may communicate directly with wireless beacons 130 using short range communications, such as Bluetooth Low Energy, LTE Direct, radio frequency, infrared, Bluetooth, and near field communications.

Service provider server 150 may be maintained, for example, by a service provider entity, which may provide notification services to merchants, as well as towns, cities, municipalities, counties, states, governmental agencies, land or location owners, or other entities. In this regard, service provider server 150 includes one or more processing applications which may be configured to interact with communication device 110, wireless beacons, and/or display device 140 to provide notifications to user 102, for example, on display device 140. In one example, service provider server 150 may be provided by EBAY®, Inc. of San Jose, Calif., USA and/or PAYPAL®, Inc. of San Jose, Calif., USA. However, in other embodiments, service provider server 150 may be maintained by or include a service provider, which may provide notification services to user 102.

Service provider server 150 of FIG. 1 includes a context notification module 152, other applications 154, a database 156, and a network interface component 158. Context notification module 152 and other applications 154 may correspond to executable processes, procedures, and/or applications with associated hardware. In other embodiments, service provider server 150 may include additional or different modules having specialized hardware and/or software as required.

Context notification module 152 may correspond to one or more processes to execute modules and associated specialized hardware of service provider server 150 to receive an identifier for user 102 and/or communication device 110 from one or more of wireless beacons 130, access location context information for a location associated with the one or more of wireless beacons 130, determine vehicle and/or user information for the vehicle user 102 is travelling in and/or user 102 and associated users (e.g., users travelling with user 102), and generate a notification for display device 140 and/or communication device 110. In this regard, context notification module 152 may correspond to specialized hardware and/or software to receive an identifier for user 102 and/or communication device 110, where the identifier is first received from a connection between communication device 110 and one or more of wireless beacon 130 (e.g., based on connection information generated from the connection). Once the identifier is received from the one or more of wireless beacons 130, context notification module 152 may access location context information for a location at or nearby the one or more of wireless beacons 130. The location context information may be received from an entity associated with the location (e.g., a merchant, an administrator of governing body of the location, or other responsible/managing party), or may be determined based on crowd sourced information for the location. Where context notification module 152 relies on crowd sourced information, context notification module 152 may pull and/or scrape one or more sources, such as communication devices including mobile smart phones and vehicle devices, online sources (e.g., merchants for the location and other entities at or nearby the location), and/or social accounts of one or more users.

Location context information may correspond to contextual information about the location. Thus, location context information may include information about merchants nearby a location and one or more items sold by the merchant (including services with the item, such as oil and an oil change, tires and tire installation, etc.). Such merchants may offer both personal items (e.g., food, drink, or other shopping interests) and vehicle use and maintenance items (e.g., gas, oil, tires, radiator fluid, lights, air conditioner and heater repair or maintenance, etc.). Location context information may also include occurrences at or nearby the location, and/or vehicle use requirements, guidance, and suggestions for operation of a vehicle at or nearby the location. For example, location context information may include road conditions, required or suggested vehicle parameters for traversing a travel route at or nearby the location, weather, traffic, and/or accidents at the location or along a travel route throughout and nearby the location. Location context information may be tied to travel through and/or nearby the location. For example, location context information may include snowy conditions, hot conditions, poor road or construction context at the location, or other types of conditions and contexts at or nearby the location.

Where the location context information corresponds to vehicle use requirements, guidance, and suggestions for operation of a vehicle at or nearby the location, the location context information may include information about a type of vehicle for use or nearby the location, a type of tire required at or nearby the location, a type of vehicle drivetrain required at or nearby the location, a type of safety belt or harness required at or nearby the location, required safety lighting at or nearby the location, necessary oil requirements at or nearby the location, necessary radiator fluid requirements at or nearby the location, required tire pressure at or nearby the location, necessary interior cooling or heating at or nearby the location, necessary gas levels at or nearby the location, and necessary electrical requirements at or nearby the location. Such information may be tied to vehicle requirements at or nearby the location and may be mandatory (e.g., the vehicle may not proceed without meeting the requirements) or suggested (e.g., the vehicle may proceed but may have difficulties or encounter issues, such as impassable terrain, breakdown, etc.). The information may also be guidance or suggestions for the area, such as a suggested fuel amount based on a distance to a next refueling station, suggested heating/cooling for an interior of the vehicle to be comfortable, an amount of oil or radiator fluid to prevent damage to an engine, or other guideline for care and maintenance of the user's vehicle. In such embodiments, the vehicle requirements, suggestions, and/or guidance may be set by an administrator for the location, including governmental entities, or may be set from crowd sourced information based on vehicle information that has travelled through the location and/or travel route through and nearby the location

Context notification module 152 may further determine vehicle information for a vehicle user 102 is travelling in and/or utilizing. Vehicle information may correspond to general information specific to the vehicle, including make, model, year, and any other general information available for the vehicle (e.g., engine type/cylinders, drivetrain, etc.). The vehicle information may also include information specific to the particular vehicle, such as miles, oil levels and distance since change, tire wear, and other maintenance and wear parameters of the specific vehicle. Utilizing the vehicle information with the location context information, context notification module 152 may determine a notification for display to user 102. The notification may be general based on the location context information, such as a notice to obtain snow tires and/or chains, or may be specific to the vehicle for user 102, for example, if context notification module 152 determines the vehicle user 102 is travelling in does not have snow chains based on the vehicle information. The notification may include only required information based on the location context information and vehicle information, or may also include suggestions. For example, user 102 may be alerted that user 102 cannot continue without snow chains for required areas. However, suggestions may alert user 102 that user 102 should increase their tire pressure or fill up on gas where user 102 may be low but not required to change the condition.

Context notification module 152 may further determine user information in order to provide a notification having an advertisement for a merchant at or nearby the location that may provide an item of interest to user 102 and/or users travelling in the vehicle, such as food, drink, merchandise, etc. The user information may be based on a purchase history of user 102 and/or the other users. The user information may also include set preferences by user 102 and/or the other users, and parameters for user 102 and/or the other users, such as age, location, interests, etc. Thus, context notification module 152 may determine the notification using the user information to provide an advertisement for goods, merchandise, consumables, and other items of interest.

The notification may also include information about nearby traffic, weather, accident, or other driving condition information. Context notification module 152 may determine the notification generally to provide warning to user 102. However, context notification module 152 may also determine the notification based on the vehicle and user information to be specific to the vehicle and/or user 102. In such embodiments, the notification may be provided to user 102 to provide user 102 with adequate notice to prepare, stop, turn around, or other avoid/consider upcoming emergencies and driving conditions.

Once the notification is determined, context notification module 152 may communicate the notification to display device 140 for display to user 102. As discussed herein, context notification module 152 may also determine a best time for display device 140 to display the notification, which may be utilized when communicating the notification to display device 140. Context notification module 152 may utilize a network connection over network 160 to communicate the notification to wireless beacons 130, which may utilize short range wireless communications to transmit the notification to display device 140. In other embodiments, context notification module 152 may transmit the notification over network 160 directly to display device 140.

In various embodiments, service provider server 150 includes other applications 154 as may be desired in particular embodiments to provide features to service provider server 150. For example, other applications 154 may include security applications for implementing client-side security features, programmatic client applications for interfacing with appropriate application programming interfaces (APIs) over network 160, or other types of applications. Other applications 154 may contain software programs, executable by a processor, including a graphical user interface (GUI), configured to provide an interface to user 102 when accessing service provider server 150. In various embodiments where not provided by context notification module 152, other applications 154 may include connection and/or communication applications, which may be utilized to communication information to over network 160.

Additionally, service provider server 150 includes database 156. Database 156 may be utilized to store information utilized by one or more modules and/or applications of service provider server 150, including context notification module 152 and/or other applications 154. In this regard, database 156 may include received and/or determined information, including identifiers and other connection information, location context information, vehicle and user information, and notifications determined using the aforementioned information.

In various embodiments, service provider server 150 includes at least one network interface component 158 adapted to communicate communication device 110, wireless beacons 130, and/or display device 140 over network 160. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

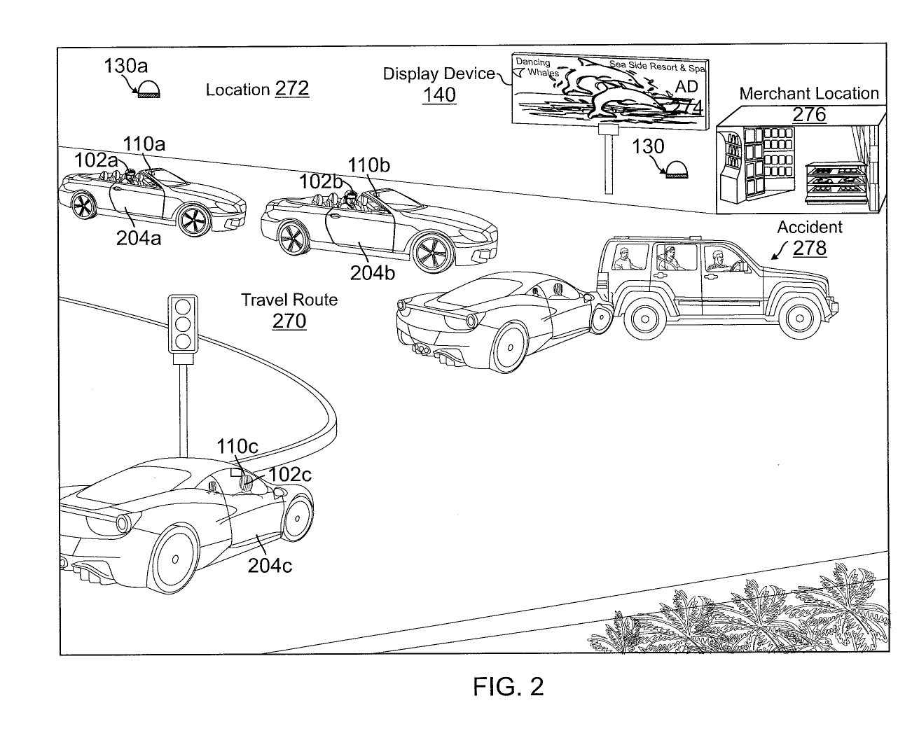

FIG. 2 is an exemplary environment having a travel route where users are provided contextually relevant notifications on billboard display devices and other communication or display devices, according to an embodiment. Environment 200 of FIG. 2 includes a user 102a utilizing a communication device 110a, a user 102b utilizing a communication device 110b, and a user 102c utilizing a communication device 110c, all corresponding generally to user 102 utilizing communication device 110, respectively, of FIG. 1. Environment 200 further includes a wireless beacon 130a and a wireless beacon 130b corresponding generally to wireless beacons 130 of FIG. 1. Moreover, FIG. 2 includes display device 140 having the described hardware and software as described in FIG. 1.

Environment 200 includes a location 272 where users 102a-c may travel along a travel route 270 at, throughout, and/or nearby location 272. For example, user 102a operates a vehicle 204a, user 102b operates a vehicle 204b, and user 102c operates vehicle 204c at different points along travel route 270. Users 102a-c may be in possession of communication devices 110a-c, respectively, while travelling on travel route 270, so that communication devices 110a-c may connect with wireless beacon 130a. Communication devices 110a-c may communicate an identifier associated with users 102a-c, respectively, to wireless beacon 130a, so that a service provider associated with wireless beacon 130a may receive the identifiers and associate users 102a-c with location 272.

For example, as user 102a arrives at location 272 and communication device 110a connects to wireless beacon 130a, the service provider (e.g., a device or server for the service provider) may determine that user 102a is at or associated with location 272 after receiving an identifier for user 102a from wireless beacon 130a. The service provider may then access location context information for location 272, which may include information along travel route 270 (e.g., a sub-location in location 272 having display device 140, an accident 278, and/or merchant location 276). The service provider may then access vehicle information for vehicle 204a and/or user information for user 102a. The service provider may utilize the aforementioned information to determine a notification for user 102a. The notification may later be displayed on display device 140, where user 102a may view the notification. In other embodiments, the notification may be displayed to user 102a through communication device 110a (which may correspond to a mobile smart phone or other type of personal computing device or a vehicle device).

Thus, after user 102b has been associated with location 272 based on a connection between communication device 110b and wireless beacon 130a, the service provider may determine a notification specific to user 102b and/or vehicle 204b for display on display device 140. As user 102b is shown in vehicle 204b at or approaching display device 140, display device 140 may display an ad 274, which may correspond to the notification for user 102b. Display device 140 may receive ad 274 over a network connection or through short range wireless communications with wireless beacon 130b. Display device 140 may then display ad 274 when user 102b may view ad 274 on display device 140, which may be targeted to user 102b based on vehicle information for vehicle 204b and/or user information for user 102b. Ad 274 may include an advertisement for merchant location 276 along travel route 270 at, nearby, or to location 272. Thus, user 102b may stop at merchant location 276 to purchase or receive items targeted to user 102b through ad 274.

Additionally, user 102c may be near an accident 278 along travel route 270. Using vehicle information for vehicle 204c and location context information for location 272 showing that accident 278 occurred along travel route 270, the service provide may determine that user 102c requires a sufficient amount of notice of accident 278 to stop prior to accident 278 and/or avoid accident 278 (e.g., through rerouting). Thus, as user 102c passes wireless beacon 130b, wireless beacon 130b may communicate a notification including information for accident 278 to user 102c on communication device 110c. The notification may provide a map or other information allowing identification of a location for accident 278 and required safety and/or rerouting instructions.

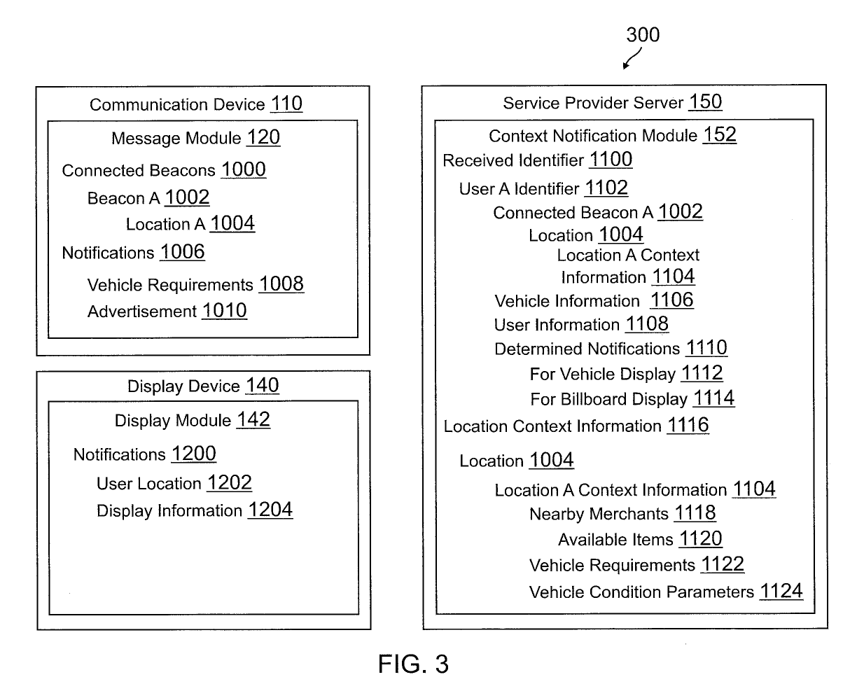

FIG. 3 is an exemplary system environment having a user's communication device and a billboard display device receiving contextually relevant notifications based on location context information, vehicle information, and user information, according to an embodiment. Environment 300 includes communication device 110, display device 140, and service provider server 150 of FIG. 1. The below described hardware and/or software modules execute functions as described herein with respect to environment 100.

Communication device 110 executes message module 120 having specialized hardware and/or software modules and processes described herein in reference to FIG. 1. In this regard, message module 120 displays one or more notifications received from service provider server 150. Communication device 110 may first connect with a wireless beacon at a location generate connection information having an identifier for the user/communication device 110. For example, message module 120 includes connected beacons 1000, which may include a beacon A 1002 at a location A 1004. The connection information from the connection to beacon A 1002 may be communicated to service provider server 150, which executes context notification module 152 having specialized hardware and/or software modules and processes described herein in reference to FIG. 1. Thus, context notification module 152 includes a received identifier 1100 from the connection established with the wireless beacon.

Received identifier 1100 may be utilized to determine one or more notifications. For example, received identifier 1100 may include user A identifier 1102, which may be utilized to determine and/or access related information, including connected beacon A 1002 communicating user A identifier 1102 to service provider server 150. Connected beacon A 1002 includes associated information having a location 1004, which includes location A context information 1104. Location A context information 1104 may be determined from accessible information to context notification module 152, which may include location context information 1116. Location context information 1116 may be received from various entities associated with the location and/or determined using crowd sourced and scrapped information. Location context information 1116 includes location 1004, as well as other locations in various embodiments. Location 1004 in location context information 1116 includes location A context information 1104, which includes nearby merchants 1118 having available items 1120, vehicle requirements 1122, and vehicle condition parameters 1124.

User A identifier 1102 further includes vehicle information 1106, which may be determined and/or accessed using user A identifier 1102, for example, from pulling the information from a communication device (e.g., a mobile smart phone, personal computing device, and/or vehicle device). Vehicle information 1106 may also be determined by accessing the information from a local or remote database, including maintenance service provider databases. Information used to determine a notification may also include user information 1108, in various embodiments. Using the aforementioned information, context notification module 152 may generate determined notifications 1110, which may include notifications for vehicle display 1112 and notifications for billboard display 1114.

Once context notification module 152 generates determined notifications 1110, determined notification for billboard display 1114 may be communicated to display device 140. Display device 140 executes display module 142 having specialized hardware and/or software modules and processes described herein in reference to FIG. 1. Display module 142 may receive and/or access notification 1200 received from service provider server 150. Notification 1200 may be output through an output device, where display module 142 may utilize user location 1202 and display information 1204 to display notification 1200. Moreover, message module 120 may display notifications received from service provider server 150, such as notifications 10006, which may include displayable information for vehicle requirements 1008 and an advertisement 1010.

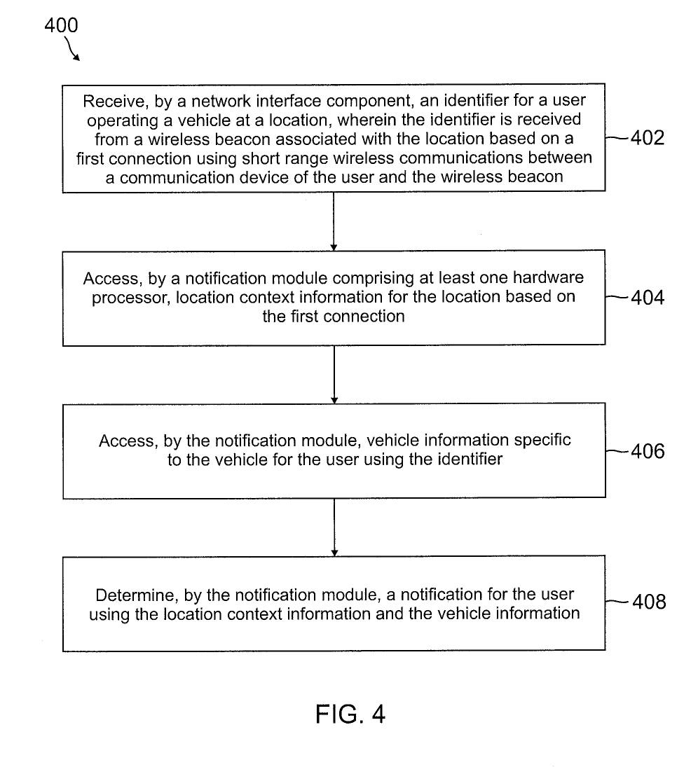

FIG. 4 is a flowchart of an exemplary process for contextually aware billboard display devices using wireless beacon device communications, according to an embodiment. Note that one or more steps, processes, and methods described herein may be omitted, performed in a different sequence, or combined as desired or appropriate.

At step 402, an identifier for a user operating a vehicle at a location is received, for example, by a network interface component and/or accessed by a notification module comprising at least one hardware processor, wherein the identifier is received from a first wireless beacon located at the location based on a first connection using short range wireless communications between a communication device of the user and the first wireless beacon. The short range wireless communications may comprise one of one of near field communications, radio communications, infrared communications, Bluetooth communications, Bluetooth Low Energy (BLE) communications, LTE Direct communications, and WiFi communications.

At step 404, location context information for the location is accessed based on the first connection, by the notification module. The location context information may comprise a list of items available from at least one merchant at or nearby the first location. The location context information may also comprise at least one of general vehicle requirements and general vehicle maintenance parameters for use of vehicles at or nearby the location. The general vehicle requirements may comprises a type of vehicle for use or nearby the location, a type of tire required at or nearby the location, a type of vehicle drivetrain required at or nearby the location, a type of safety belt or harness required at or nearby the location, and required safety lighting at or nearby the location. Additionally, the general vehicle maintenance parameters may comprise at least one of necessary oil requirements at or nearby the location, necessary radiator fluid requirements at or nearby the location, required tire pressure at or nearby the location, necessary interior cooling or heating at or nearby the location, necessary gas levels at or nearby the location, and necessary electrical requirements at or nearby the location. Thus, the location context information may comprise driving conditions at or nearby the location, and wherein the notification comprises an alert to the user of the driving conditions. The list of items may also comprise food and drink items available from the at least one merchant. In various embodiments, the notification module determines the location context information, wherein the location context information is determined using crowd sourced information based on other vehicle information pulled from at least one other vehicle utilized at or nearby the location.

Vehicle information specific to the vehicle for the user is accessed, by the notification module, using the identifier, at step 406. The vehicle information may comprise use requirements for the vehicle, wherein the vehicle information is based on at least one of vehicle usage and at least one vehicle condition parameter. The notification module may determine the vehicle information by utilizing the network interface component to pull the vehicle information from the communication device, wherein the communication device comprises one of a mobile smart phone, a vehicle console computing device, and a vehicle heads up display device. In other embodiments, the notification module may determine the vehicle information by accessing a vehicle use history for the vehicle, wherein the vehicle use history is one of stored to the database and retrievable from a maintenance entity associated with the vehicle. In various embodiments, the vehicle information may comprise a time the vehicle is passing through or nearby the area, wherein the notification module further accesses user information for the user and further determines the notification using the user information. Additionally, the user information may comprise at least one of purchase history for the user, a personal status of the user, and additional users traveling with the user in the vehicle.

At step 408, a notification for the user is determined, by the notification module, using the location context information and the vehicle information. The display device may comprise a billboard display device located at or nearby the first location. The notification may be communicated to the at least one display device through at least one of a network connection with the at least one display device, the first beacon located at the location and in communication with the at least one display device, and a second beacon located nearby the location and in communication with the at least one display device. The at least one display device may also comprise a mobile smart phone of the user, a vehicle console computing device of the vehicle, and a vehicle heads up display device of the vehicle. The notification may comprise an advertisement for at least one of the items and the at least one merchant. The advertisement may be specific to the vehicle based on the vehicle information. In further embodiments, the notification may alert the user of at least one condition of the vehicle that violates the at least one of the general vehicle requirements and does not meet the general vehicle maintenance parameters.

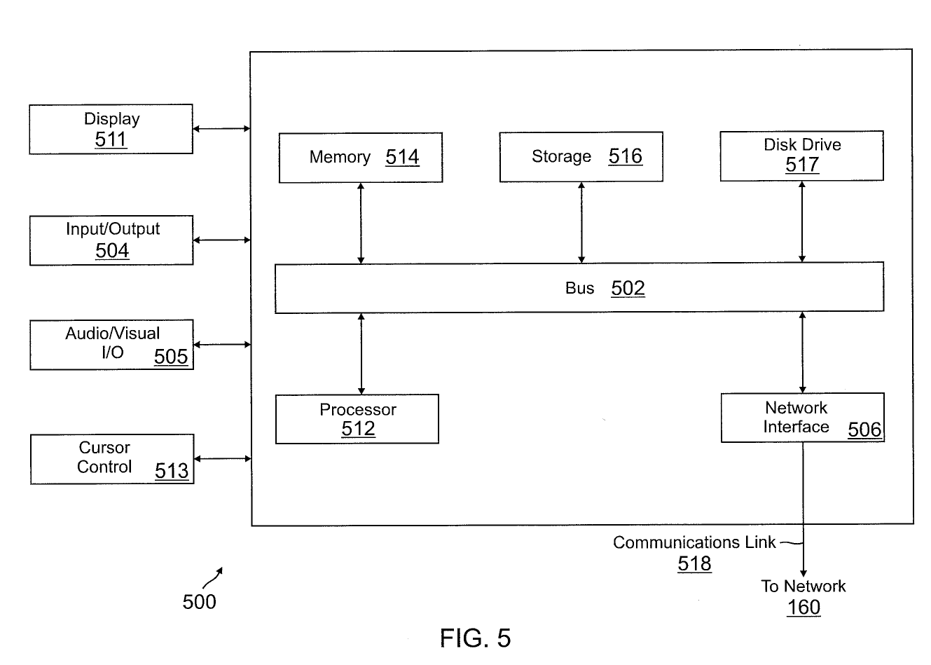

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a notification module comprising at least one hardware processor that accesses an identifier for a user operating a vehicle at a first location, wherein the identifier is received from a wireless beacon associated with the first location based on a first connection using short range wireless communications between a communication device of the user and the wireless beacon, accesses location context information for the first location based on the first connection, determines vehicle information specific to the vehicle for the user using the identifier, and determines a notification for the user using the location context information and the vehicle information;
a database stored to a non-transitory memory that stores the identifier, the location context information, and the notification; and
a network interface component that receives the identifier and communicates the notification to at least one display device for display of the notification to the user while the user is associated with the first location.

2. The system of claim 1, wherein the display device comprises a billboard display device located at or nearby the first location.

3. The system of claim 1, wherein the short range wireless communications comprise one of radio communications, infrared communications, Bluetooth communications, Bluetooth Low Energy (BLE) communications, LTE Direct communications, and WiFi communications.

4. The system of claim 1, wherein the location context information comprises a list of items available from at least one merchant at or nearby the first location.

5. The system of claim 4, wherein the notification comprises an advertisement for at least one of the items and the at least one merchant

6. The system of claim 5, wherein the advertisement is specific to the vehicle based on the vehicle information.

7. The system of claim 6, wherein the vehicle information comprises use requirements for the vehicle, and wherein the vehicle information is based on at least one of vehicle usage and at least one vehicle condition parameter.

8. The system of claim 7, wherein the notification module determines the vehicle information by utilizing the network interface component to pull the vehicle information from the communication device, and wherein the communication device comprises one of a mobile computing device, a vehicle console computing device, and a vehicle heads up display device.

9. The system of claim 7, wherein the notification module determines the vehicle information by accessing a vehicle use history for the vehicle, and wherein the vehicle use history is one of stored to the database and retrievable from a maintenance entity associated with the vehicle.

10. The system of claim 7, wherein the location context information comprises at least one of general vehicle requirements and general vehicle maintenance parameters for use of vehicles at or nearby the location, and wherein the notification alerts the user of at least one condition of the vehicle that violates the at least one of the general vehicle requirements and does not meet the general vehicle maintenance parameters.

11. The system of claim 10, wherein the general vehicle requirements comprises a type of vehicle for use or nearby the location, a type of tire required at or nearby the location, a type of vehicle drivetrain required at or nearby the location, a type of safety belt or harness required at or nearby the location, and required safety lighting at or nearby the location, and wherein the general vehicle maintenance parameters comprise at least one of necessary oil requirements at or nearby the location, necessary radiator fluid requirements at or nearby the location, required tire pressure at or nearby the location, necessary interior cooling or heating at or nearby the location, necessary fuel or power levels at or nearby the location, and necessary electrical requirements at or nearby the location.

12. The system of claim 10, wherein the notification module further determines the location context information, and wherein the location context information is determined using crowd sourced information based on other vehicle information pulled from at least one other vehicle utilized at or nearby the location.

13. The system of claim 4, wherein the list of items comprise food and drink items available from the at least one merchant.

14. The system of claim 13, wherein the vehicle information comprises a time the vehicle is passing through or nearby the area, and wherein the notification module further accesses user information for the user and further determines the notification using the user information.

15. The system of claim 14, wherein the user information comprises at least one of purchase history for the user, a personal status of the user, and additional users traveling with the user in the vehicle.

16. A method comprising:
receiving, by a network interface component, an identifier for a user operating a vehicle at a location, wherein the identifier is received from a first wireless beacon located at the location based on a first connection using short range wireless communications between a communication device of the user and the first wireless beacon;
accessing, by a notification module comprising at least one hardware processor, location context information for the location based on the first connection;
accessing, by the notification module, vehicle information specific to the vehicle for the user using the identifier;
determining, by the notification module, a notification for the user using the location context information and the vehicle information; and
communicating, by the network interface component, the notification to at least one display device for display of the notification to the user while the user is associated with the location.

17. The method of claim 16, wherein the location context information comprises driving conditions at or nearby the location, and wherein the notification comprises an alert to the user of the driving conditions.

18. The method of claim 17, the notification is communicated to the at least one display device through at least one of a network connection with the at least one display device, the first beacon located at the location and in communication with the at least one display device, and a second beacon located nearby the location and in communication with the at least one display device.

19. The method of claim 18, wherein the at least one display device comprises at least one of a billboard device, a mobile computing device of the user, a vehicle console computing device of the vehicle, and a vehicle heads up display device of the vehicle.

20. A non-transitory computer-readable medium comprising executable modules which, in response to execution by a computer system, cause the computer system to perform a method comprising:
receiving, by a network interface component, an identifier for a user operating a vehicle at a location, wherein the identifier is received from a wireless beacon established at or nearby the location based on a first connection using short range wireless communications between a communication device of the user and the wireless beacon;
accessing, by a notification module comprising at least one hardware processor, location context information for the location based on the first connection;
accessing, by the notification module, vehicle information specific to the vehicle for the user using the identifier;
determining, by the notification module, a notification for the user using the location context information and the vehicle information; and
communicating, by the network interface component, the notification to at least one display device for display of the notification to the user while the user is associated with the location.
